(19) United States
(12) Patent Application Publication
(10) Pub. No.: US 2023/0397103 A1
(43) Pub. Date: Dec. 7, 2023

(54) DORMANCY STATES FOR USER EQUIPMENT POWER SAVING

(71) Applicant: QUALCOMM Incorporated, San Diego, CA (US)

(72) Inventors: Ahmed ELSHAFIE, San Diego, CA (US); Seyedkianoush HOSSEINI, San Diego, CA (US); Wei YANG, San Diego, CA (US)

(21) Appl. No.: 17/805,431

(22) Filed: Jun. 3, 2022

(51) Int. Cl. H04W 52/02; H04W 72/04; H04W 24/08; H04W 24/10

(52) U.S. Cl. CPC H04W 52/0212; H04W 72/0453; H04W 52/0229; H04W 24/10; H04W 24/08

(57) ABSTRACT

Various aspects of the present disclosure generally relate to wireless communication. In some aspects, a user equipment (UE) may receive an indication of a first dormancy state, of a plurality of dormancy states, for a set of frequency resources within a bandwidth part of a component carrier, wherein each dormancy state of the plurality of dormancy states is associated with a respective set of activities that are enabled for that dormancy state. The UE may switch the set of frequency resources to the first dormancy state. Numerous other aspects are described.

### FIELD OF THE DISCLOSURE

Aspects of the present disclosure generally relate to wireless communication and to techniques and apparatuses for dormancy states for user equipment (UE) power saving.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive an indication of a first dormancy state, of a plurality of dormancy states, for a set of frequency resources within a bandwidth part of a component carrier, wherein each dormancy state of the plurality of dormancy states is associated with a respective set of activities that are enabled for that dormancy state. The one or more processors may be configured to switch the set of frequency resources to the first dormancy state.

Some aspects described herein relate to a method of wireless communication performed by a UE. The method may include receiving an indication of a first dormancy state, of a plurality of dormancy states, for a set of frequency resources within a bandwidth part of a component carrier, wherein each dormancy state of the plurality of dormancy states is associated with a respective set of activities that are enabled for that dormancy state. The method may include switching the set of frequency resources to the first dormancy state.

Some aspects described herein relate to a non-transitory computer-readable medium that stores a set of instructions for wireless communication by a UE. The set of instructions, when executed by one or more processors of the UE, may cause the UE to receive an indication of a first dormancy state, of a plurality of dormancy states, for a set of frequency resources within a bandwidth part of a component carrier, wherein each dormancy state of the plurality of dormancy states is associated with a respective set of activities that are enabled for that dormancy state. The set of instructions, when executed by one or more processors of the UE, may cause the UE to switch the set of frequency resources to the first dormancy state.

Some aspects described herein relate to an apparatus for wireless communication. The apparatus may include means for receiving an indication of a first dormancy state, of a plurality of dormancy states, for a set of frequency resources within a bandwidth part of a component carrier, wherein each dormancy state of the plurality of dormancy states is associated with a respective set of activities that are enabled for that dormancy state. The apparatus may include means for switching the set of frequency resources to the first dormancy state.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIGS. 5-6 are diagrams illustrating examples associated with dormancy states for UE power saving, in accordance with the present disclosure.

FIG. 7 is a diagram illustrating an example process associated with dormancy states for UE power saving, in accordance with the present disclosure.

FIG. 8 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

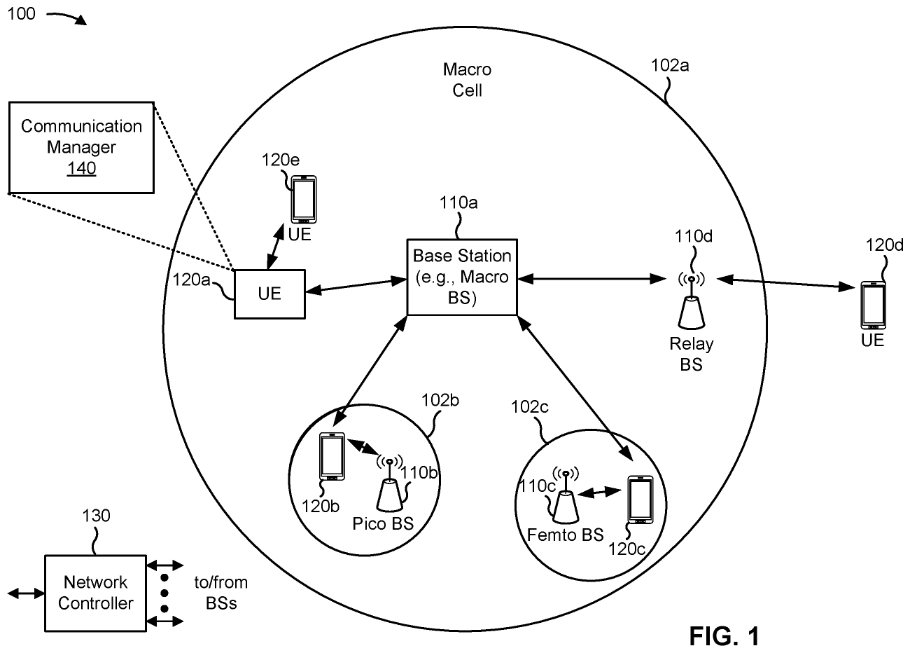

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication of a first dormancy state, of a plurality of dormancy states, for a set of frequency resources within a bandwidth part of a component carrier, wherein each dormancy state of the plurality of dormancy states is associated with a respective set of activities that are enabled for that dormancy state; and switch the set of frequency resources to the first dormancy state. Additionally, or alternatively, the communication manager 140 may perform one or more other operations described herein.

As indicated above, FIG. 1 is provided as an example. Other examples may differ from what is described with regard to FIG. 1.

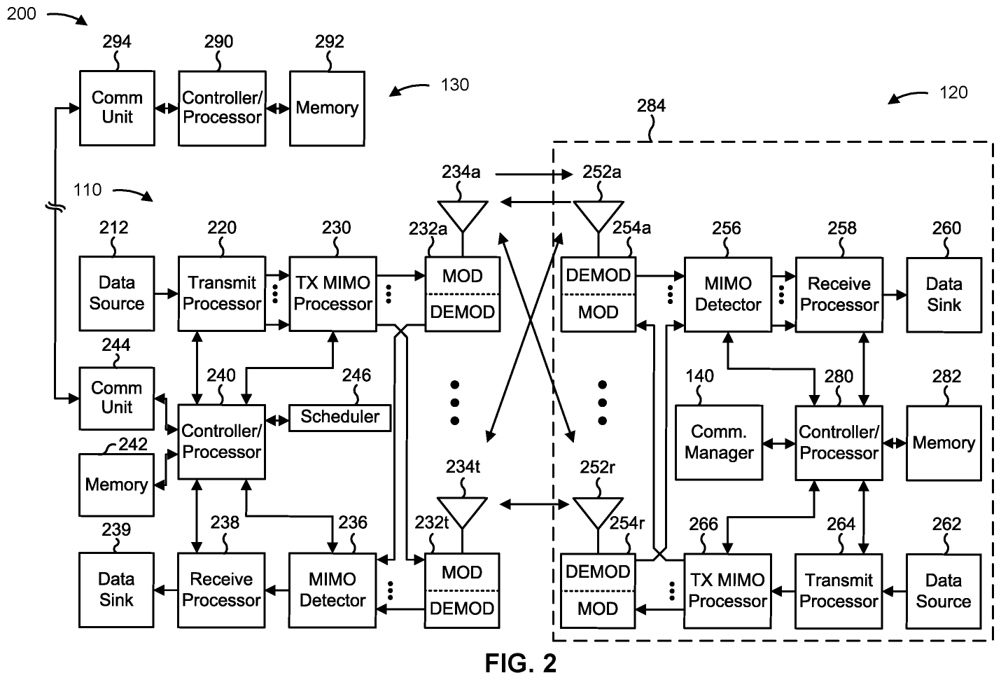

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

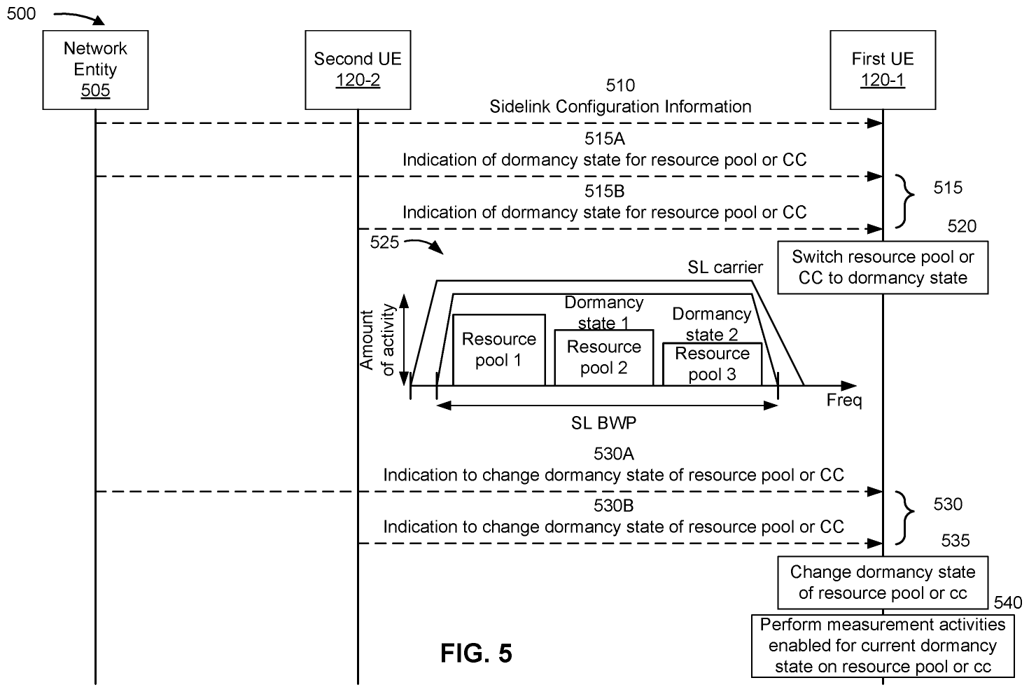

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-8).

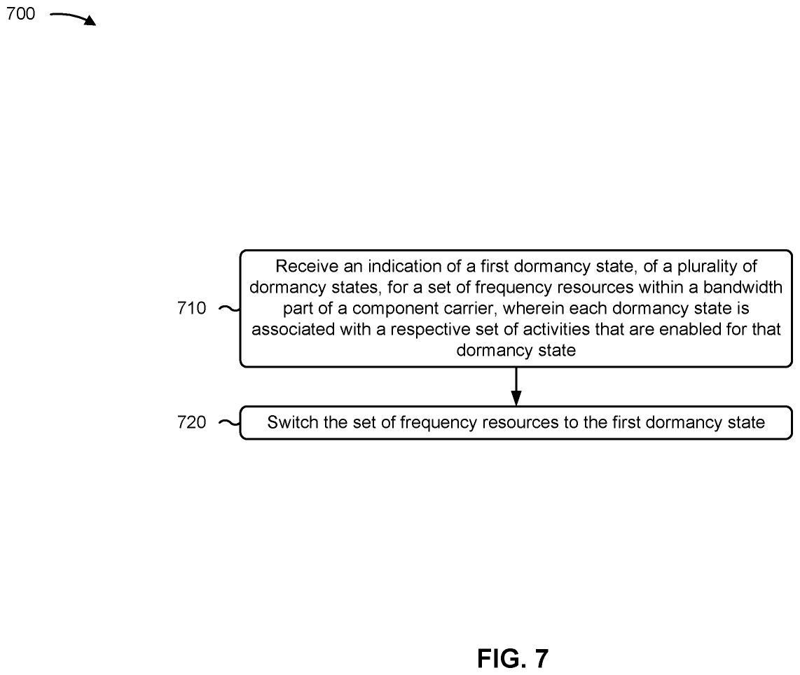

The controller/processor 240 of the base station 110, the controller/processor 280 of the UE 120, and/or any other component(s) of FIG. 2 may perform one or more techniques associated with dormancy states for UE power saving, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, and/or other processes as described herein. In some examples, executing instructions may include running the instructions, converting the instructions, compiling the instructions, and/or interpreting the instructions, among other examples.

In some aspects, the UE 120 includes means for receiving an indication of a first dormancy state, of a plurality of dormancy states, for a set of frequency resources within a bandwidth part of a component carrier, wherein each dormancy state of the plurality of dormancy states is associated with a respective set of activities that are enabled for that dormancy state; and/or means for switching the set of frequency resources to the first dormancy state. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR base station (BS), 5G NB, gNodeB (gNB), access point (AP), TRP, or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

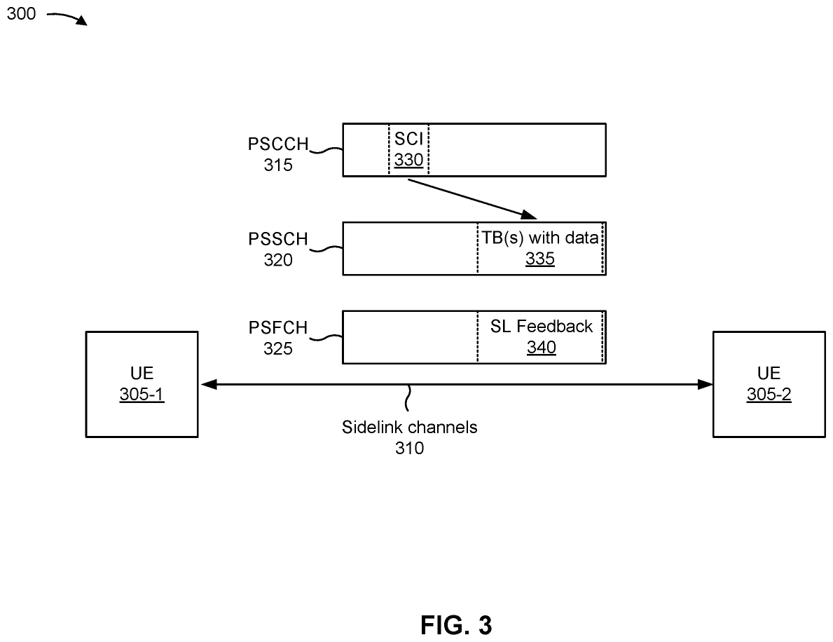

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some examples, the UEs 305 (e.g., UE 305-1 and/or UE 305-2) may correspond to one or more other UEs described elsewhere herein, such as UE 120. In some examples, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330 (e.g., first stage SCI (SCI-1)) which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement (ACK) or negative acknowledgement (NACK) information).

Although shown on the PSCCH 315 in FIG. 3, in some examples, the SCI 330 may include multiple communications in different stages. For example, SCI-1 may be transmitted on the PSCCH 315, and second stage SCI (SCI-2) may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process identifier (ID), a new data indicator (NDI), a source identifier, a destination identifier, and/or a channel state information (CSI) report trigger.

In some examples, the one or more sidelink channels 310 may use resource pools. For example, a scheduling assignment (e.g., included in SCI 330) may be transmitted in sub-channels using specific resource blocks (RBs) across time. In some examples, data transmissions (e.g., on the PSSCH 320) associated with a scheduling assignment (e.g., SCI-1) may occupy adjacent RBs in the same slot as the scheduling assignment (e.g., using frequency division multiplexing).

In some examples, a UE 305 may operate using a resource allocation mode (e.g., Mode 1) in which a base station allocates resources for sidelink communications between UEs 305. In some examples, a UE 305 may operate using a resource allocation mode (e.g., Mode 2) in which resource selection and/or scheduling is autonomously performed by the UE 305 (e.g., rather than a base station 110). In some examples, the UE 305 may perform resource selection and/or scheduling by sensing channel availability for transmissions using Mode 2. For example, the UE 305 may measure an RSSI parameter (e.g., a sidelink-RSSI (S-RSSI) parameter) associated with various sidelink channels, may measure an RSRP parameter (e.g., a PSSCH-RSRP and/or PSCCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 carried in the PSCCH 315 (e.g., SCI-1), which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of RBs that the UE 305 can use for a particular set of subframes).

In the resource allocation mode 2 where resource selection and/or scheduling is performed by a UE 305, the UE 305 may generate sidelink grants with reserved resources and may transmit the grants in SCI 330. A sidelink grant may indicate, for example, one or more parameters (e.g., transmission parameters) to be used for an upcoming sidelink transmission, such as one or more subchannels to be used for the upcoming sidelink transmission on the PSSCH 320 (e.g., for TBs 335), one or more slots to be used for the upcoming sidelink transmissions, and/or an MCS to be used for the upcoming sidelink transmission. In some examples, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an aperiodic sidelink transmission.

As indicated above, FIG. 3 is provided as an example. Other examples may differ from what is described with respect to FIG. 3.

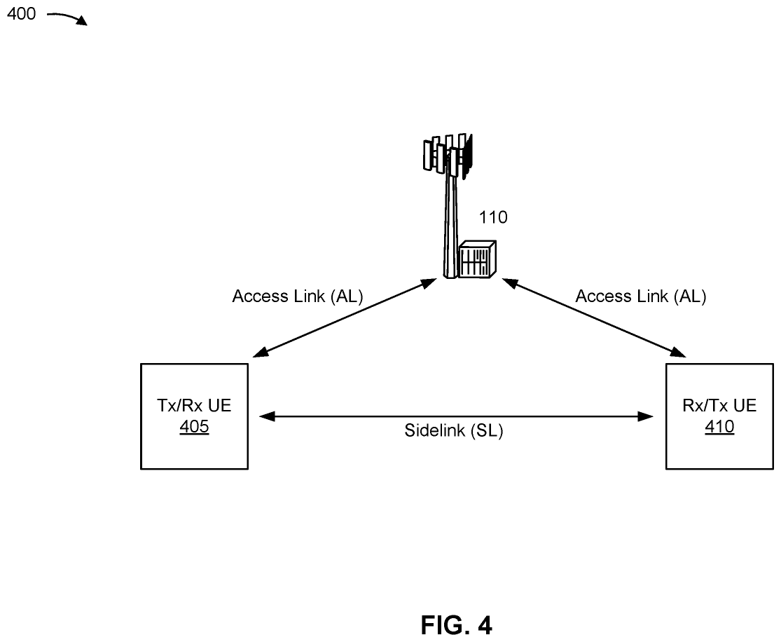

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink resource allocation modes, a base station 110 may communicate with the Tx/Rx UE 405 via a first access link. Additionally, or alternatively, in some sidelink resource allocation modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

In some examples, a UE 120 may be configured with multiple bandwidth parts (BWPs) per carrier (e.g., component carrier (CC)) for downlink and uplink (e.g., up to four BWPs per carrier for downlink and up to four BWPs per carrier for uplink), but only one BWP per carrier may be active for downlink and one BWP per carrier may be active for uplink at a given time. When a base station 110 configures a BWP for a UE 120, the base station may configure parameters for the BWP including BWP numerology (u), BWP bandwidth size, frequency location (e.g., NR absolute radio-frequency channel number (NR-ARFCN)), and a control resource set (CORESET) for the BWP. In this case, the UE 120 is expected to receive and transmit only within the frequency range configured for the active BWPs with the associated numerologies. In some cases (e.g., in Rel-16 of the 3GPP wireless communication standard), multiple sidelink BWPs on a sidelink carrier (e.g., sidelink CC) may not be supported in NR/5G sidelink communications. That is, in some cases, only one sidelink BWP may be configured and activated for all UEs on a sidelink carrier, and only one sidelink carrier may be supported for NR/5G sidelink communications.

In some examples, a UE 120 may be configured with a set of resource pools in a sidelink BWP. The set of resource pools in the sidelink BWP may include one or more Rx resource pools and one or more Tx resource pools. Each Rx resource pool identifies a set of frequency resources (e.g., subchannels) and time resources for receiving sidelink communications from other UEs. Each Tx resource pool identifies a set of frequency resources (e.g., subchannels) and time resources for transmitting sidelink communications to other UEs. In some examples (e.g., in Rel-16 of the 3GPP wireless communication standard), up to 16 Rx resource pools and up to 8 Tx resource pools may be configured in a sidelink BWP. In some examples, the physical layer sidelink channels (e.g., PSSCH, PSCCH, and PSFCH) may be configured per resource pool.

As indicated above, FIG. 4 is provided as an example. Other examples may differ from what is described with respect to FIG. 4.

In some cases, a single sidelink BWP may be configured in a sidelink carrier. A sidelink BWP with a wide operation bandwidth may have increased data rates for sidelink communications relative to a narrower operation bandwidth. However, a UE may scan or monitor all resources/subchannels in the frequency domain of the sidelink BWP (e.g., in all of the Rx resource pools configured in the sidelink BWP) regardless of how much traffic the UE has or expects. Thus, the use of a wide sidelink BWP (e.g., a single BWP) for all UEs may result in high power consumption, which is not desirable, particularly for many types of UEs, such industrial IoT (IIoT) devices and/or wearable devices, among other examples.

Some techniques and apparatuses described herein enable a UE to receive (e.g., from a network entity or from another UE) an indication of a first dormancy state, of a plurality of dormancy states, for a set of frequency resources within a BWP of a CC. Each dormancy state, of the plurality of dormancy states, may be associated with a respective set of activities that are enabled for that dormancy state. The UE may switch the set of frequency resources to the first dormancy state in connection with receiving the indication. While the resource pool is in the first dormancy state, the UE may refrain from (or reduce) other activities that are not associated with or enabled for that dormancy state. As a result, the UE may reduce power consumption (e.g., as compared with monitoring all of the resource pools configured in the sidelink BWP). Furthermore, the different sets of activities, such as measurement activities, with different levels of power consumption, are enabled at different dormancy states of the plurality of dormancy states. As a result, different dormancy states may be used for one or more resource pools within the sidelink BWP to balance power saving and utilization of the sidelink BWP for the UE.

In some aspects, an indicated dormancy state, of a plurality dormancy states associated with different sets of activities, may be applied to a set of frequency resources within a BWP of a CC used for communications via the Uu interface (e.g., downlink and uplink communications). In this way, the UE may reduce power consumption for communications on the Uu interface.

FIG. 5 is a diagram illustrating an example 500 associated with dormancy states for UE power saving, in accordance with the present disclosure. As shown in FIG. 5, example 500 includes communication between a network entity 505 (e.g., a base station 110, CU, DU, RU, or a combination thereof), a first UE 120-1, and a second UE 120-2. In some aspects, the network entity 505 and the UEs 120 (e.g., the first UE 120-1 and the second UE 120-2) may be included in a wireless network, such as wireless network 100. The network entity 505 and the UEs 120 may communicate via a wireless access link (e.g., via a Uu interface), which may include an uplink and a downlink. The first UE 120-1 and the second UE 120-2 may communication via sidelink communications (e.g., via a PC5 interface). In some aspects, the first UE 120-1 may be an Rx UE for one or more sidelink communications, and the second UE 120-2 may be a Tx UE for one or more sidelink communications. In some aspects, the first UE 120-1 may be a Tx UE for one or more sidelink communications, and the second UE 120-2 may be an Rx UE for one or more sidelink communications.

As shown in FIG. 5, and by reference number 510, the network entity 505 may transmit sidelink configuration information to the first UE 120-1. The first UE 120-1 may receive the sidelink configuration information transmitted by the network entity 505. For example, the sidelink configuration information may be included in a radio resource control (RRC) message (or multiple RRC messages) transmitted from the network entity 505 to the first UE 120-1.

The sidelink configuration information may include a configuration of a sidelink CC (e.g., sidelink carrier) to be used by the first UE 120-1 for sidelink communications. In some aspects, the sidelink configuration information may include a configuration of a single sidelink CC. In some aspects, the sidelink configuration information may include configurations of multiple sidelink CCs that can be used for sidelink communications for the first UE 120-1 (e.g., using sidelink carrier aggregation). The sidelink configuration information may include a sidelink BWP configuration that identifies a sidelink BWP in the sidelink CC. In some aspects, in a case in which multiple sidelink CCs are configured for the first UE 120-1, the sidelink BWP configuration may identify a respective sidelink BWP in each sidelink CC. In some aspects, a single sidelink BWP may be configured for the first UE 120-1 in a sidelink CC. In some aspects, multiple sidelink BWPs may be configured in a sidelink CC.

The sidelink configuration information may include resource pool configurations for a set of resource pools configured within a sidelink BWP in a sidelink CC. For example, the set of resource pools in the sidelink BWP may include one or more Rx resource pools and one or more Tx resources (e.g., including one or more Tx resources pools for mode 1 sidelink transmissions and/or one or more Tx resource pools for mode 2 sidelink transmissions), and the sidelink configuration information may include a respective resource pool configuration for each resource pool of the set of resource pools. The resource pool configuration, for a resource pool in the set of resource pools configured within the sidelink BWP, may include a configuration of the physical layer channels (e.g., PSSCH, PSSCH, and PSFCH) for the resource pool. The resource pool configuration, for a resource pool of the set of resource pools, may also include information identifying a number of subchannels, a subchannel, a starting RB, a CBR, an MCS, a sensing configuration, and/or a power control configuration for the resource pool.

In some aspects, the sidelink configuration information may include a configuration of a plurality of dormancy states. “Dormancy state” refers to a state of reduced monitoring of, and/or reduced transmission on, a set of frequency resources (e.g., one or more resource pools within a sidelink BWP in a sidelink CC), relative to a non-dormant state or activated state, in connection with inactivity (e.g., expected future inactivity or measured past inactivity) on the set of frequency resources. A non-dormant state, or activated state, refers to a state in which the UE monitors all resources in a set of frequency resources (e.g., one or more Rx resource pools within a sidelink BWP in a sidelink CC) and/or the UE may transmit on all resources in a set of frequency resources (e.g., one or more Tx resource pools within a sidelink BWP. In some cases, “dormancy mode,” “dormant state,” or “dormant mode” may be used interchangeably with “dormancy state.” In some aspects, when a resource pool is in a dormancy state, the UE may still perform some activities using the resource pool. For example, the UE may perform some measurement activities using a resource pool when the resource pool is in the dormancy state. “Measurement activities” refers to measurements or sensing performed by the UE, other operations relating to measurements or sensing, such as communications (relating to measurements or sensing performed by the UE (e.g., reporting of the measurements or sensing results) and/or communications relating to measurements to be performed by another device (e.g., another UE).

In some aspects, each dormancy state, of the plurality of dormancy states, may be associated with a respective set of measurement activities that are enabled for that dormancy state. The configuration of the plurality of dormancy states may identity the plurality of dormancy states and the respective set of measurement activities enabled for each dormancy state of the plurality of dormancy states. In some aspects, the set of activities (e.g., measurement activities) enabled for a dormancy state may include one or more measurements to be performed by the UE and/or reporting to be performed by the UE. In some aspects, the set of activities may include measurements and reporting of the measurements with a same frequency as a frequency at which the measurements are to be performed. In some aspects, the set of activities may include measurements and reporting of the measurements with a different frequency from a frequency at which the measurements are to be performed. For example, the measurement activities enabled to be performed by a first UE 120-1 in a resource pool in a configured dormancy state may include CBR measurements, CSI measurements and reporting, sensing measurements, positioning reference signal and/or sidelink reference signal transmission, transmission of positioning reports (e.g., to assist in positioning other devices), and/or various combinations thereof. Different measurement activities and/or combinations of measurement activities may be enabled for different dormancy states of the plurality of dormancy states. For example, different dormancy states may be configured with different amounts of activities enabled, and the different dormancy states may provide different levels of power saving for the UE. In some aspects, different dormancy states, of the plurality of dormancy states, may be associated with different levels of inactivity or dormancy in a resource pool or sidelink CC.

In some aspects, one of the resource pools configured within a sidelink BWP in a sidelink CC may be configured as a primary resource pool (or default resource pool), and the other resource pools configured within the sidelink BWP may be configured as secondary resource pools. The primary resource pool may define the minimum bandwidth in the sidelink BWP that is to be monitored/managed by the first UE 120-1 (e.g., if all of the other resource pools are in a dormancy state). In some aspects, the primary resource pool may always remain in a non-dormant or activated state. In some aspects, the primary resource pool may be switched only to a dormancy state in which monitoring for and managing dormancy communications from other UEs is enabled.

In some aspects, in a case in which multiple sidelink CCs are configured for sidelink communications, one of the sidelink CCs may be configured as a primary CC. In some aspects, the resource pools in the primary CC may always remain in a non-dormant or activated state. In some aspects, the resource pools in the primary CC may be switched only to a dormancy state in which monitoring for and managing dormancy communications from other UEs is enabled.

As further shown in FIG. 5, and by reference number 515, the first UE 120-1 may receive an indication of a dormancy state for a resource pool or a sidelink CC. As shown by reference number 515A, in some aspects, the network entity 505 may transmit, to the first UE 120-1, an indication of a dormancy state for a resource pool or a sidelink CC, and the first UE 120-1 may receive the indication of the dormancy state transmitted by the network entity 505. As shown by reference number 515B, in some aspects, the second UE 120-2 may transmit, to the first UE 120-1, an indication of a dormancy state for a resource pool or a sidelink CC, and the first UE 120-1 may receive the indication of the dormancy state transmitted by the second UE 120-2.

The indication may be an indication for the first UE 120-1 to switch a resource pool or a sidelink CC into the indicated dormant state (e.g., from a non-dormant state). In some aspects, the network entity 505 may transmit the indication to the first UE 120-1 via layer 1 (L1) signaling (e.g., in downlink control information (DCI) or a Uu wake-up signal (WUS)), layer 2 (L2) signaling (e.g., in a medium access control (MAC) control element (MAC-CE)), or layer (L3) signaling (e.g., in an RRC message). In some aspects, the second UE 120-2 may transmit the indication to the first UE 120-1 via L1 signaling (e.g., in SCI (for example, SCI-2 in two-stage SCI), a sidelink WUS, or a dedicated PSSCH signal for indicating the dormancy state), a L2 signaling (e.g., in a PC5 MAC-CE), or L3 signaling (e.g., in a PC5 RRC message).

In some aspects, the indication may indicate a dormancy state, of the plurality of dormancy states, for a resource pool of a set of resource pools configured in a sidelink BWP in a sidelink CC. For example, the indication may indicate a first dormancy state, of the plurality of dormancy states, for a first resource pool of the set of resource pools configured in the sidelink BWP of the sidelink CC. For example, the first resource pool, for which the first dormancy state is indicated, may be a secondary resource pool. In some aspects, the same signaling (e.g., L1, L2, or L3 signaling) may be used to indicate a particular dormancy state (e.g., the first dormancy state), of the plurality of dormancy states, for multiple resource pools in the set of resource pools configured in the sidelink BWP in a sidelink CC. In some aspects, the indication may indicate a dormancy state (e.g., the first dormancy state), of the plurality of dormancy states, for a CC (e.g., for all resource pools within the sidelink CC). For example, the CC, for which the first dormancy state is indicated, may be a secondary CC (e.g., a CC other than the primary CC). In some aspects, the same signaling (e.g., L1, L2, or L3 signaling) may be used to indicate a particular dormancy state (e.g., the first dormancy state), of the plurality of dormancy states, for multiple CCs.

As further shown in FIG. 5, and by reference number 520, the first UE 120-1 may switch a resource pool or a sidelink CC to a dormancy state. For example, the first UE 120-1 may switch a resource pool or a sidelink CC from a non-dormant state to a dormancy state. In some aspects, in connection with receiving the indication of a dormancy state for a resource pool or a sidelink CC (e.g., from the network entity 505 or the second UE 120-2), the first UE 120-1 may switch a resource pool or the sidelink CC to the indicated dormancy state. For example, in a case in which the indication indicates a first dormancy state for a first resource pool of the set of resource pools within the sidelink BWP in the sidelink CC, first UE 120-1 may switch the first resource pool to the first dormancy state. In a case in which the indication indicates a first dormancy state for a sidelink CC, the first UE 120-1 may switch all of the resource pools configured within the sidelink CC to the first dormancy state.

In some aspects, the first UE 120-1 may switch a resource pool or a sidelink CC to a dormancy state independent of an indication received from the network entity 505 or the second UE 120-2. For example, the first UE 120-1 may switch a resource pool (or a sidelink CC) to a configured dormant state in connection with a determination that no traffic is received or transmitted by the first UE 120-1 on the resource pool for a certain time duration. In some aspects, the first UE 120-1 may be configured with a timer associated with a dormancy state. The first UE 120-1 may reset the timer for a resource pool each time traffic is received or transmitted by the first UE 120-1 on the resource pool. In this case, the first UE 120-1 may switch a resource pool to the dormancy state in connection with detecting the expiration of the timer associated with the dormancy state. In some aspects, the first UE 120-1 may be configured with multiple timers (e.g., with different time durations) that trigger switching a resource pool to different dormant states of the plurality of dormant states.

In some aspects, the first UE 120-1 may switch different resource pools within a sidelink BWP in a sidelink CC to different dormancy states. For example, as shown by reference number 525, the first UE 120-1 may be configured with resource pool 1, resource pool 2, and resource pool 3, in a sidelink BWP of a sidelink carrier (e.g., sidelink CC). Resource pool 1 may be in a non-dormant state (e.g., not switched to a dormant state), resource pool 2 may be in a first dormancy state (dormancy state 1), and resource pool 3 may be in a second dormancy state (dormancy state 2). In this dormancy state 1 may be associated with a first set of measurement activities that are enabled for dormancy state 1, dormancy state 2 may be associated with a second set of measurement activities that are enabled for dormancy state 2, and the amount of measurement activities enabled for dormancy state 1 may be greater than the amount of measurement activities enabled for dormancy state 2.

As further shown in FIG. 5, and by reference number 530, the first UE 120-1 may receive an indication to change the dormancy state of a resource pool or sidelink CC. In some aspects, the indication may be an indication to change the dormancy state of a resource pool or sidelink CC from a first dormancy state to a second dormancy state. For example, the first UE 120-1 may receive an indication of the second dormancy state for a resource pool (or sidelink CC) that is currently in the first dormancy state. In some aspects, the indication may be an indication to change the dormancy state for the resource pool or sidelink CC to a less active dormancy state. In some aspects, the indication may be an indication to change the dormancy state for the resource pool or sidelink CC to a more active dormancy state. In some aspects, the indication may be an indication to change the dormancy state for the resource pool or sidelink CC from a dormancy state to a non-dormant state (e.g., activated state).

As shown by reference number 530A, in some aspects, the network entity 505 may transmit, to the first UE 120-1, an indication to change the dormancy state of a resource pool or sidelink CC, and the first UE 120-1 may receive the indication to change the dormancy state transmitted by the network entity 505. In some aspects, the network entity 505 may transmit the indication to change the dormancy state of a resource pool (or sidelink CC) to the first UE 120-1 via L1 signaling (e.g., via DCI (for example, DCI format 3_x) or a Uu WUS), L2 signaling (e.g., in a MAC-CE), or L3 signaling (e.g., in an RRC message). For example, the network entity 505 may transmit the indication to activate one or more resource pools configured for the first UE 120-1 (e.g., from a dormancy state to a non-dormant state).

As shown by reference number 530A, in some aspects, the second UE 120-2 may transmit, to the first UE 120-1, an indication to change the dormancy state of a resource pool or sidelink CC, and the first UE 120-1 may receive the indication to change the dormancy state transmitted by the second UE 120-2. In some aspects, the second UE 120-2 may transmit the indication to change the dormancy state of a resource pool (or sidelink CC) to the first UE 120-1 via L1 signaling (e.g., in SCI, a sidelink WUS, or a dedicated PSSCH signal for indicating the change in dormancy state), L2 signaling (e.g., in a PC5 MAC-CE), or L3 signaling (e.g., in a PC5 RRC message). For example, the first UE 120-1 may be configured/preconfigured to monitor sidelink WUSs from the second UE 120-2, and a sidelink WUS transmitted by the second UE 120-2 may also indicate, to the first UE 120-1, to change the dormancy level of one or more resource pools after waking up.

In some aspects, in a case in which the second UE 120-2 transmits, to the first UE 120-1, an indication to change the dormancy state of a first resource pool (or first sidelink CC) that is a secondary resource pool (or secondary sidelink CC), the L1, L2, or L3 signaling indicating the change to the dormancy state of the first resource pool (or first sidelink CC) may be transmitted to the first UE 120-1 in a second resource pool (or second sidelink CC) configured for the first UE 120-1. In some aspects, the second resource pool (or sidelink CC), in which the indication is received by the first UE 120-1, may be the primary resource pool (or sidelink CC). In some aspects, the second resource pool (or sidelink CC), in which the indication is received by the first UE 120-1, may be a secondary resource pool with activated HARQ-ACK feedback (e.g., activated PSFCH) that is agreed to by the first UE 120-1 and the second UE 120-2.

In some aspects, the network entity 505 may transmit, to the second UE 120-2, an indication to change the dormancy state of a resource pool configured for the second UE 120-2, and the second UE 120-2 may transmit, to the first UE 120-1, an indication to change the dormancy state of a resource pool configured for the first UE 120-1 based at least in part on the change to the dormancy state of the resource pool configured for the second UE 120-2. In some aspects, the network entity 505 may transmit, to the first UE 120-1, an indication to change the dormancy state of a resource pool configured for the first UE 120-1, and the first UE 120-1 may transmit, to the second UE 120-2, an indication to change the dormancy state of a resource pool configured for the second UE 120-2 based at least in part on the change to the dormancy state of the resource pool configured for the first UE 120-1.

As further shown in FIG. 5, and by reference number 535, the first UE 120-1 may change the dormancy state of a resource pool or a sidelink CC. For example, the first UE 120-1 may change the dormancy state of a resource pool (or sidelink CC) from a first dormancy state, of the plurality of dormancy states, to a second dormancy state, of the plurality of dormancy states, in connection with receiving (e.g., from the network entity 505 or the second UE 120-2) an indication to change the dormancy state of the resource pool (or sidelink CC).

As further shown in FIG. 5, and by reference number 540, the first UE 120-1 may perform one or more measurement activities on a resource pool or sidelink CC that are enabled for a current dormancy state of the resource pool of sidelink CC. Each dormancy state, of the plurality of dormancy states, may be associated with a respective set of measurement activities that are enabled for that dormancy state. The first UE 120-1 may perform, on a resource pool, one or more measurement activities in the set of measurement activities associated with the current dormancy state of a resource pool. For example, a first dormancy state, of the plurality of dormancy states, may be associated with a first set of measurement activities that are enabled for the first dormancy state. In this case, while a resource pool is in the first dormancy state, the first UE 120-1 may perform one or more measurement activities, in the first set of measurement activities, on the resource pool in the first dormancy state.

In some aspects, the L1, L2, or L3 indication received by the first UE 120-1 (e.g., from the network entity 505 or the second UE 120-2) may indicate the type of measurements and/or activities that the UE will perform in the resource pools. For example, the dormancy state indicated for a resource pool by the L1, L2, or L3 indication may map to a configured set of measurement activities to be performed by the first UE 120-1 in the resource pool, while the resource pool is in the indicated dormancy state. Additionally, or alternatively, in some aspects, the L1, L2, or L3 indication may include a dynamic indication that changes the set of measurements enabled in the dormancy state. For example, the L1, L2, or L3 indication may dynamically enable one or more measurement activities not included in the configured set of measurement activities associated with the indicated dormancy state, and/or dynamically disable one or more measurement activities included in the configured set of measurement activities associated with the indicated dormancy state.

In some aspects, CBR measurements or calculations may be enabled for a current dormancy state of one or more dormant resource pools (or sidelink CCs). In this case, the first UE 120-1 may perform CBR measurements or calculations over a set of occasions (e.g., predefined or configured occasions) in the one more dormant resource pools (or sidelink CCs) while in the current dormancy state. For example, the CBR measurements may be used by the first UE 120-1 to determine parameter restrictions for power control when the first UE 120-1 switches to the currently dormant resource pools (or sidelink CCs) for sidelink communications.

In some aspects, CSI measurements may be enabled for a current dormancy state of one or more dormant resource pools (or sidelink CCs). In this case, the first UE 120-1 may perform one or more CSI measurements (e.g., to assist other UEs or the network entity 505 to allocate resources, or to determine the channel quality) in the one or more dormant resource pools (or sidelink CCs) while in the current dormancy state. In some aspects, the first UE 120-1 may transmit CSI reports including the CSI measurements on some configured locations using the primary sidelink CC, the primary resource pool within the sidelink BWP of a sidelink CC, or another agreed upon secondary resource pool. In some aspects, the first UE 120-1 may transmit the CSI reports using a dormant resource pool (or sidelink CC), if CSI report transmission is enabled (e.g., included in the set of enabled measurement activities) for the current dormancy state of the dormant resource pool (or sidelink CC).

In some aspects, sensing activity (e.g., for inter-UE coordination, where a UE assists another UE or set UEs) may be enabled for a current dormancy state of one or more dormant resource pools. In this case, performing one or more sensing measurements to for one or more other UEs in the one or more dormant resource pool while in the current dormancy state. In some aspects, the first UE 120-1 may transmit the sensing results/outcome, by request from the one or more other UEs, to the Tx UE that transmitted the dormancy indication (e.g., the second UE 120-2), or to the one or more other UEs in a groupcast or broadcast, on some dedicated resources on the primary resource pool, a dedicated (secondary) resource pool with a dormancy state in which transmitting the sending results is enabled, or the resource pool in which the sensing measurements are performed.

In some aspects, transmission of sidelink reference signals or position reference signals to other devices (e.g., other UEs) may be enabled for a current dormancy state of a dormant resource pool. In this case, the first UE 120-1 may transmit at least one of a sidelink reference signal or a positioning reference signal in the dormant resource pool while in the current dormancy state.

In some aspects, transmission of positioning reports to assist other devices (e.g., other UEs) with positioning may be enabled for a current dormancy state of a dormant resource pool. In this case, the first UE 120-1 may transmit one or more positioning reports in the dormant resource pool while in the current dormancy state. For example, the positioning reports may include angle of arrival (AoA) position estimates, time or arrival (ToA) position estimates, or a combination thereof.

In some aspects, the operations described in connection with FIG. 5 and elsewhere herein for resource pools for sidelink communications may be similarly performed for resources for communications via the Uu interface (e.g., resources for downlink and/or uplink communications. For example, an indicated dormancy state, of a plurality dormancy states associated with different sets of activities, may be applied to a set of frequency resources within a BWP of a CC used for communications via the Uu interface. In some aspects, such as for an enhanced reduced capability (RedCap) UE, each BWP for communications via the Uu interface may be split into sub-bands, where a sub-band includes a set of physical resource blocks (PRBs) similar to a resource pool for sidelink communications. In this case, the dormancy states may be applied to the sub-bands for communications via the Uu interface similarly to resource pools for sidelink communications, as described in FIG. 5 and elsewhere herein.

As indicated above, FIG. 5 is provided as an example. Other examples may differ from what is described with respect to FIG. 5.

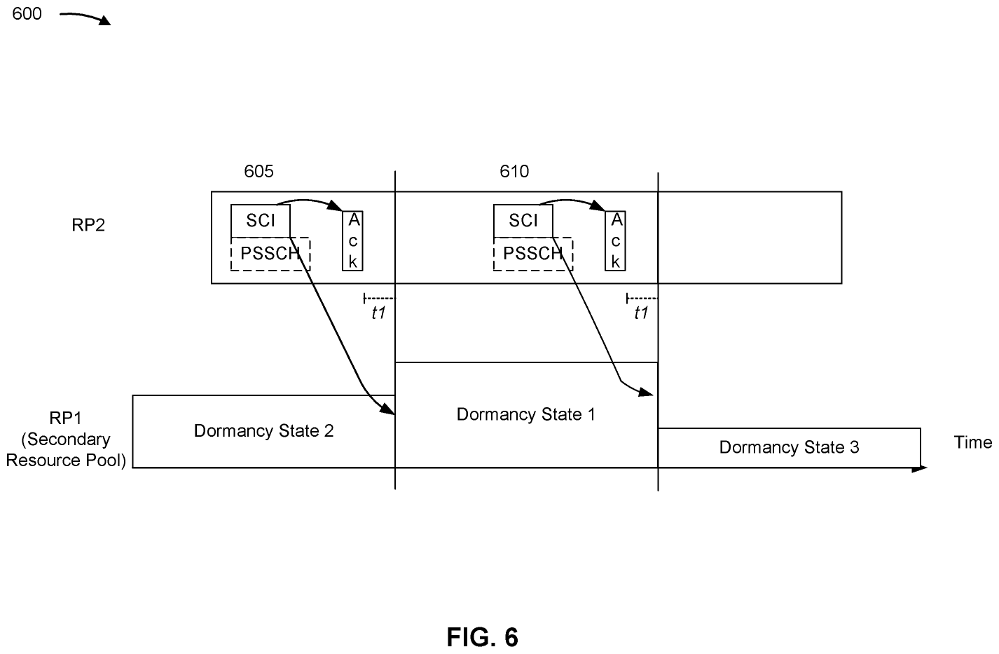

FIG. 6 is a diagram illustrating an example 600 associated with dormancy states for UE power saving, in accordance with the present disclosure. As shown in FIG. 6, example 600 shows an example of switching a dormancy state of a first resource pool (RP1) configured for a first UE. As shown in FIG. 6, RP1 is a secondary resource pool, and the first UE may receive, in a second resource pool (RP2) configured for the first UE, signaling from a second UE that indicates changes the dormancy state of RP1. In some aspects, RP2 may be the primary resource pool within the sidelink BWP in the sidelink CC. In some aspects, RP2 may be a secondary resource pool that is configured with an activated PSFCH (e.g., with activated HARQ-ACK feedback) and is agreed on between the UEs.

As shown by reference number 605, the first UE may receive, in RP2, L1 signaling from the second UE that includes a first indication to change the dormancy state of RP1 to dormancy state 1. For example, the first indication to change the dormancy state of RP1 to dormancy state 1 may be included in SCI or may be indicated by a dedicated PSSCH signal received from the second UE in RP2. In other examples, the first indication may be included L2 or L3 signaling received in RP2. The first UE may transmit ACK feedback to the second UE via the PSFCH. The first UE, in connection with receiving the first indication from the second UE, may change the dormancy state of RP1 from dormancy state 2 to dormancy state 1. As shown in FIG. 6, in some aspects, the first UE may switch the dormancy state of RP1 to the dormancy state indicated by the first indication (e.g., dormancy state 1) after a time offset ti from the transmission of the ACK feedback associated with the first indication.

As shown by reference number 610, the first UE may receive, in RP2, L1 signaling from the second UE that includes a second indication to change the dormancy state of RP1 to dormancy state 3. For example, the second indication to change the dormancy state of RP1 to dormancy state 3 may be included in SCI or may be indicated by a dedicated PSSCH signal received from the second UE in RP2. In other examples, the second indication may be included L2 or L3 signaling received in RP2. The first UE may transmit ACK feedback to the second UE via the PSFCH. The first UE, in connection with receiving the second indication from the second UE, may change the dormancy state of RP1 from dormancy state 1 to dormancy state 3. In some aspects, the first UE may switch the dormancy state of RP1 to the dormancy state indicated by the second indication (e.g., dormancy state 3) after a time offset ti from the transmission of the ACK feedback associated with the second indication.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120) performs operations associated with dormancy states for user equipment power saving.

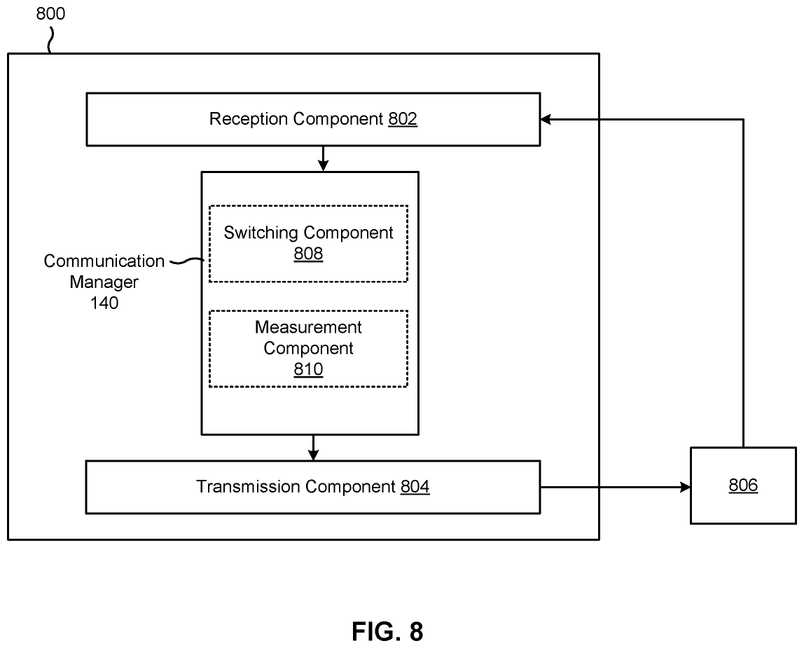

As shown in FIG. 7, in some aspects, process 700 may include receiving an indication of a first dormancy state, of a plurality of dormancy states, for a set of frequency resources within a bandwidth part of a component carrier, wherein each dormancy state of the plurality of dormancy states is associated with a respective set of activities that are enabled for that dormancy state (block 710). For example, the UE (e.g., using communication manager 140 and/or reception component 802, depicted in FIG. 8) may receive an indication of a first dormancy state, of a plurality of dormancy states, for a set of frequency resources within a bandwidth part of a component carrier, wherein each dormancy state of the plurality of dormancy states is associated with a respective set of activities that are enabled for that dormancy state, as described above.

As further shown in FIG. 7, in some aspects, process 700 may include switching the set of frequency resources to the first dormancy state (block 720). For example, the UE (e.g., using communication manager 140 and/or switching component 808, depicted in FIG. 8) may switch the set of frequency resources to the first dormancy state, as described above.

Process 700 may include additional aspects, such as any single aspect or any combination of aspects described below and/or in connection with one or more other processes described elsewhere herein.

In a first aspect, the component carrier is a sidelink component carrier, the bandwidth part is a sidelink bandwidth part in the sidelink component carrier, and the set of frequency resources includes at least one resource pool of a set of resource pools configured in the sidelink bandwidth part.

In a second aspect, receiving the indication includes receiving the indication from another UE, and the indication is included in SCI, a dedicated PSSCH signal, a sidelink WUS, a MAC-CE, or an RRC message.

In a third aspect, receiving the indication includes receiving the indication from a network entity, and the indication is included in DCI, a Uu WUS, a MAC-CE, or an RRC message.

In a fourth aspect, the indication indicates the first dormancy state for a first resource pool of the set of resource pools configured in the sidelink bandwidth part and switching the set of frequency resource to the first dormancy state includes switching the first resource pool to the first dormancy state.

In a fifth aspect, the set of resource pools includes a primary resource pool and one or more secondary resource pools, and the first resource pool is a secondary resource pool of the one or more secondary resource pools.

In a sixth aspect, process 700 includes receiving an indication of a second dormancy state, of the plurality of dormancy states, for a second resource pool of the set of resource pools configured in the sidelink bandwidth part and switching the second resource pool to the second dormancy state.

In a seventh aspect, process 700 includes receiving an indication of a second dormancy state, of the plurality of dormancy states, for the first resource pool, and switching the first resource pool from the first dormancy state to the second dormancy state.

In an eighth aspect, receiving the indication of the second dormancy state for the first resource pool includes receiving the indication of the second dormancy state for the first resource pool from another UE.

In a ninth aspect, receiving the indication of the second dormancy state for the first resource pool from another UE includes receiving the indication of the second dormancy state for the first resource pool from another UE in a second resource pool of the set of resource pools configured in the sidelink bandwidth part.

In a tenth aspect, receiving the indication of the second dormancy state for the first resource pool includes receiving the indication of the second dormancy state for the first resource pool from a network entity.

In an eleventh aspect, the indication indicates the first dormancy state for the sidelink component carrier and switching the set of frequency resources to the first dormancy state includes switching all of the resource pools in set of resource pools configured in the sidelink bandwidth part in the sidelink component carrier to the first dormancy state.

In a twelfth aspect, the first dormancy state is associated with a first set of activities that are enabled for the first dormancy state, and further comprising performing one or more activities, in the first set of activities, in the at least one resource pool while the at least one resource pool is in the first dormancy state.

In a thirteenth aspect, performing the one or more activities, in the first set of activities, in the at least one resource pool while the at least one resource pool is in the first dormancy state includes performing CBR measurements over a set of occasions in the at least one resource pool while the at least one resource pool is in the first dormancy state.

In a fourteenth aspect, performing the one or more activities, in the first set of activities, in the at least one resource pool while the at least one resource pool is in the first dormancy state includes performing one or more CSI measurements in the at least one resource pool while the at least one resource pool is in the first dormancy state.

In a fifteenth aspect, performing the one or more activities, in the first set of activities, in the at least one resource pool while the at least one resource pool is in the first dormancy state includes performing one or more sensing measurements for one or more other UEs in the at least one resource pool while the at least one resource pool is in the first dormancy state.

In a sixteenth aspect, performing the one or more activities, in the first set of activities, in the at least one resource pool while the at least one resource pool is in the first dormancy state includes transmitting at least one of a sidelink reference signal or a positioning reference signal in the at least one resource pool while the at least one resource pool is in the first dormancy state.

In a seventeenth aspect, performing the one or more activities, in the first set of activities, in the at least one resource pool while the at least one resource pool is in the first dormancy state includes transmitting one or more positioning reports in the at least one resource pool while the at least one resource pool is in the first dormancy state.

In an eighteenth aspect, the first set of activities includes at least one of one or more measurements to be performed by the UE or reporting to be performed by the UE.

In a nineteenth aspect, the first set of activities includes the one or more measurements and the reporting, and a frequency of the one or more measurements is the same as a frequency of the reporting.

In a twentieth aspect, the first set of activities includes the one or more measurements and the reporting, and a frequency of the one or more measurements is different from a frequency of the reporting.

In a twenty-first aspect, process 700 includes receiving, from a network entity, a configuration of the plurality of dormancy states and the respective set of activities associated with each dormancy state of the plurality of dormancy states.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include one or more of a switching component 808 and/or a measurement component 810.

In some aspects, the apparatus 800 may be configured to perform one or more operations described herein in connection with FIGS. 5-6. Additionally, or alternatively, the apparatus 800 may be configured to perform one or more processes described herein, such as process 700 of FIG. 7, or a combination thereof. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The reception component 802 may receive an indication of a first dormancy state, of a plurality of dormancy states, for a set of frequency resources within a bandwidth part of a component carrier, wherein each dormancy state of the plurality of dormancy states is associated with a respective set of activities that are enabled for that dormancy state. The switching component 808 may switch the set of frequency resources to the first dormancy state.

The reception component 802 may receive an indication of a second dormancy state, of the plurality of dormancy states, for a second resource pool of the set of resource pools configured in the sidelink bandwidth part.

The switching component 808 may switch the second resource pool to the second dormancy state.

The reception component 802 may receive an indication of a second dormancy state, of the plurality of dormancy states, for the first resource pool.

The switching component 808 may switch the first resource pool from the first dormancy state to the second dormancy state.

The measurement component 810 may perform one or more activities, in the first set of activities, in the at least one resource pool while the at least one resource pool is in the first dormancy state

The reception component 802 may receive, from a network entity, a configuration of the plurality of dormancy states and the respective set of activities associated with each dormancy state of the plurality of dormancy states.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: receiving an indication of a first dormancy state, of a plurality of dormancy states, for a set of frequency resources within a bandwidth part of a component carrier, wherein each dormancy state of the plurality of dormancy states is associated with a respective set of activities that are enabled for that dormancy state; and switching the set of frequency resources to the first dormancy state.

Aspect 2: The method of Aspect 1, wherein the component carrier is a sidelink component carrier, the bandwidth part is a sidelink bandwidth part in the sidelink component carrier, and the set of frequency resources includes at least one resource pool of a set of resource pools configured in the sidelink bandwidth part.

Aspect 3: The method of Aspect 2, wherein receiving the indication comprises: receiving the indication from another UE, wherein the indication is included in sidelink control information (SCI), a dedicated physical sidelink shared channel (PSSCH) signal, a sidelink wake-up signal (WUS), a medium access control (MAC) control element (MAC-CE), or a radio resource control (RRC) message.

Aspect 4: The method of Aspect 2, wherein receiving the indication comprises: receiving the indication from a network entity, wherein the indication is included in downlink control information (DCI), a Uu wake-up signal (WUS), a medium access control (MAC) control element (MAC-CE), or a radio resource control (RRC) message.

Aspect 5: The method of any of Aspects 2-4, wherein the indication indicates the first dormancy state for a first resource pool of the set of resource pools configured in the sidelink bandwidth part, and wherein switching the set of frequency resource to the first dormancy state comprises: switching the first resource pool to the first dormancy state.

Aspect 6: The method of Aspect 5, wherein the set of resource pools includes a primary resource pool and one or more secondary resource pools, and wherein the first resource pool is a secondary resource pool of the one or more secondary resource pools.

Aspect 7: The method of any of Aspects 5-6, further comprising: receiving an indication of a second dormancy state, of the plurality of dormancy states, for a second resource pool of the set of resource pools configured in the sidelink bandwidth part; and switching the second resource pool to the second dormancy state.

Aspect 8: The method of any of Aspects 5-7, further comprising: receiving an indication of a second dormancy state, of the plurality of dormancy states, for the first resource pool; and switching the first resource pool from the first dormancy state to the second dormancy state.

Aspect 9: The method of Aspect 8, wherein receiving the indication of the second dormancy state for the first resource pool comprises: receiving the indication of the second dormancy state for the first resource pool from another UE.

Aspect 10: The method of Aspect 9, wherein receiving the indication of the second dormancy state for the first resource pool from another UE comprises: receiving the indication of the second dormancy state for the first resource pool from another UE in a second resource pool of the set of resource pools configured in the sidelink bandwidth part.

Aspect 11: The method of Aspect 8, wherein receiving the indication of the second dormancy state for the first resource pool comprises: receiving the indication of the second dormancy state for the first resource pool from a network entity.

Aspect 12: The method of any of Aspects 2-11, wherein the indication indicates the first dormancy state for the sidelink component carrier, and wherein switching the set of frequency resources to the first dormancy state comprises: switching all of the resource pools in set of resource pools configured in the sidelink bandwidth part in the sidelink component carrier to the first dormancy state.

Aspect 13: The method of any of Aspects 2-12, wherein the first dormancy state is associated with a first set of activities that are enabled for the first dormancy state, and further comprising: performing one or more activities, in the first set of activities, in the at least one resource pool while the at least one resource pool is in the first dormancy state.

Aspect 14: The method of Aspect 13, wherein performing the one or more activities, in the first set of activities, in the at least one resource pool while the at least one resource pool is in the first dormancy state comprises: performing channel busy ratio (CBR) measurements over a set of occasions in the at least one resource pool while the at least one resource pool is in the first dormancy state.

Aspect 15: The method of any of Aspects 13-14, wherein performing the one or more activities, in the first set of activities, in the at least one resource pool while the at least one resource pool is in the first dormancy state comprises: performing one or more channel state information (CSI) measurements in the at least one resource pool while the at least one resource pool is in the first dormancy state.

Aspect 16: The method of any of Aspects 13-15, wherein performing the one or more activities, in the first set of activities, in the at least one resource pool while the at least one resource pool is in the first dormancy state comprises: performing one or more sensing measurements for one or more other UEs in the at least one resource pool while the at least one resource pool is in the first dormancy state.

Aspect 17: The method of any of Aspects 13-16, wherein performing the one or more activities, in the first set of activities, in the at least one resource pool while the at least one resource pool is in the first dormancy state comprises: transmitting at least one of a sidelink reference signal or a positioning reference signal in the at least one resource pool while the at least one resource pool is in the first dormancy state.

Aspect 18: The method of any of Aspects 13-17, wherein performing the one or more activities, in the first set of activities, in the at least one resource pool while the at least one resource pool is in the first dormancy state comprises: transmitting one or more positioning reports in the at least one resource pool while the at least one resource pool is in the first dormancy state.

Aspect 19: The method of any of Aspects 13-18, wherein the first set of activities includes at least one of one or more measurements to be performed by the UE or reporting to be performed by the UE.

Aspect 20: The method of Aspect 19, wherein the first set of activities includes the one or more measurements and the reporting, and a frequency of the one or more measurements is the same as a frequency of the reporting.

Aspect 21: The method of Aspect 19, wherein the first set of activities includes the one or more measurements and the reporting, and a frequency of the one or more measurements is different from a frequency of the reporting.

Aspect 22: The method of any of Aspects 1-21, further comprising: receiving, from a network entity, a configuration of the plurality of dormancy states and the respective set of activities associated with each dormancy state of the plurality of dormancy states.

Aspect 23: An apparatus for wireless communication at a device, comprising a processor; memory coupled with the processor; and instructions stored in the memory and executable by the processor to cause the apparatus to perform the method of one or more of Aspects 1-22.

Aspect 24: A device for wireless communication, comprising a memory and one or more processors coupled to the memory, the one or more processors configured to perform the method of one or more of Aspects 1-22.

Aspect 25: An apparatus for wireless communication, comprising at least one means for performing the method of one or more of Aspects 1-22.

Aspect 26: A non-transitory computer-readable medium storing code for wireless communication, the code comprising instructions executable by a processor to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive an indication of a first dormancy state, of a plurality of dormancy states, for a set of frequency resources within a bandwidth part of a component carrier, wherein each dormancy state of the plurality of dormancy states is associated with a respective set of activities that are enabled for that dormancy state; and
switch the set of frequency resources to the first dormancy state.

2. The UE of claim 1, wherein the component carrier is a sidelink component carrier, the bandwidth part is a sidelink bandwidth part in the sidelink component carrier, and the set of frequency resources includes at least one resource pool of a set of resource pools configured in the sidelink bandwidth part.

3. The UE of claim 2, wherein the one or more processors, to receive the indication, are configured to:
receive the indication from another UE, wherein the indication is included in sidelink control information (SCI), a dedicated physical sidelink shared channel (PSSCH) signal, a sidelink wake-up signal (WUS), a medium access control (MAC) control element (MAC-CE), or a radio resource control (RRC) message.

4. The UE of claim 2, wherein the one or more processors, to receive the indication, are configured to:
receive the indication from a network entity, wherein the indication is included in downlink control information (DCI), a Uu wake-up signal (WUS), a medium access control (MAC) control element (MAC-CE), or a radio resource control (RRC) message.

5. The UE of claim 2, wherein the indication indicates the first dormancy state for a first resource pool of the set of resource pools configured in the sidelink bandwidth part, and wherein switching the set of frequency resource to the first dormancy state comprises:
switch the first resource pool to the first dormancy state.

6. The UE of claim 5, wherein the set of resource pools includes a primary resource pool and one or more secondary resource pools, and wherein the first resource pool is a secondary resource pool of the one or more secondary resource pools.

7. The UE of claim 5, wherein the one or more processors are further configured to:
receive an indication of a second dormancy state, of the plurality of dormancy states, for a second resource pool of the set of resource pools configured in the sidelink bandwidth part; and
switch the second resource pool to the second dormancy state.

8. The UE of claim 5, wherein the one or more processors are further configured to:
receive an indication of a second dormancy state, of the plurality of dormancy states, for the first resource pool; and
switch the first resource pool from the first dormancy state to the second dormancy state.

9. The UE of claim 8, wherein the one or more processors, to receive the indication of the second dormancy state for the first resource pool, are configured to:
receive the indication of the second dormancy state for the first resource pool from another UE.

10. The UE of claim 9, wherein the one or more processors, to receive the indication of the second dormancy state for the first resource pool from another UE, are configured to:
receive the indication of the second dormancy state for the first resource pool from another UE in a second resource pool of the set of resource pools configured in the sidelink bandwidth part.

11. The UE of claim 8, wherein the one or more processors, to receive the indication of the second dormancy state for the first resource pool, are configured to:
receive the indication of the second dormancy state for the first resource pool from a network entity.

12. The UE of claim 2, wherein the indication indicates the first dormancy state for the sidelink component carrier, and wherein switching the set of frequency resources to the first dormancy state comprises:
switch all of the resource pools in set of resource pools configured in the sidelink bandwidth part in the sidelink component carrier to the first dormancy state.

13. The UE of claim 2, wherein the first dormancy state is associated with a first set of activities that are enabled for the first dormancy state, and wherein the one or more processors are further configured to:
perform one or more activities, in the first set of activities, in the at least one resource pool while the at least one resource pool is in the first dormancy state.

14. The UE of claim 13, wherein the one or more processors, to perform the one or more activities, in the first set of activities, in the at least one resource pool while the at least one resource pool is in the first dormancy state, are configured to:
perform channel busy ratio (CBR) measurements over a set of occasions in the at least one resource pool while the at least one resource pool is in the first dormancy state.

15. The UE of claim 13, wherein the one or more processors, to perform the one or more activities, in the first set of activities, in the at least one resource pool while the at least one resource pool is in the first dormancy state, are configured to:
perform one or more channel state information (CSI) measurements in the at least one resource pool while the at least one resource pool is in the first dormancy state.

16. The UE of claim 13, wherein the one or more processors, to perform the one or more activities, in the first set of activities, in the at least one resource pool while the at least one resource pool is in the first dormancy state, are configured to:
perform one or more sensing measurements for one or more other UEs in the at least one resource pool while the at least one resource pool is in the first dormancy state.

17. The UE of claim 13, wherein the one or more processors, to perform the one or more activities, in the first set of activities, in the at least one resource pool while the at least one resource pool is in the first dormancy state, are configured to:
transmit at least one of a sidelink reference signal or a positioning reference signal in the at least one resource pool while the at least one resource pool is in the first dormancy state.

18. The UE of claim 13, wherein the one or more processors, to perform the one or more activities, in the first set of activities, in the at least one resource pool while the at least one resource pool is in the first dormancy state, are configured to:
transmit one or more positioning reports in the at least one resource pool while the at least one resource pool is in the first dormancy state.

19. The UE of claim 13, wherein the first set of activities includes at least one of one or more measurements to be performed by the UE or reporting to be performed by the UE.

20. The UE of claim 19, wherein the first set of activities includes the one or more measurements and the reporting, and a frequency of the one or more measurements is the same as a frequency of the reporting.

21. The UE of claim 19, wherein the first set of activities includes the one or more measurements and the reporting, and a frequency of the one or more measurements is different from a frequency of the reporting.

22. The UE of claim 1, wherein the one or more processors are further configured to:
receive, from a network entity, a configuration of the plurality of dormancy states and the respective set of activities associated with each dormancy state of the plurality of dormancy states.

23. A method of wireless communication performed by a user equipment (UE), comprising:
receiving an indication of a first dormancy state, of a plurality of dormancy states, for a set of frequency resources within a bandwidth part of a component carrier, wherein each dormancy state of the plurality of dormancy states is associated with a respective set of activities that are enabled for that dormancy state; and
switching the set of frequency resources to the first dormancy state.

24. The method of claim 23, wherein the component carrier is a sidelink component carrier, the bandwidth part is a sidelink bandwidth part in the sidelink component carrier, and the set of frequency resources includes at least one resource pool of a set of resource pools configured in the sidelink bandwidth part.

25. The method of claim 24, wherein receiving the indication comprises:
receiving the indication from another UE, wherein the indication is included in sidelink control information (SCI), a dedicated physical sidelink shared channel (PSSCH) signal, a sidelink wake-up signal (WUS), a medium access control (MAC) control element (MAC-CE), or a radio resource control (RRC) message.

26. The method of claim 24, wherein receiving the indication comprises:
receiving the indication from a network entity, wherein the indication is included in downlink control information (DCI), a Uu wake-up signal (WUS), a medium access control (MAC) control element (MAC-CE), or a radio resource control (RRC) message.

27. The method of claim 24, wherein the indication indicates the first dormancy state for a first resource pool of the set of resource pools configured in the sidelink bandwidth part, and wherein switching the set of frequency resource to the first dormancy state comprises:
switching the first resource pool to the first dormancy state.

28. The method of claim 27, further comprising:
receiving an indication of a second dormancy state, of the plurality of dormancy states, for the first resource pool; and
switching the first resource pool from the first dormancy state to the second dormancy state.

29. A non-transitory computer-readable medium storing a set of instructions for wireless communication, the set of instructions comprising:
one or more instructions that, when executed by one or more processors of a user equipment (UE), cause the UE to:
receive an indication of a first dormancy state, of a plurality of dormancy states, for a set of frequency resources within a bandwidth part of a component carrier, wherein each dormancy state of the plurality of dormancy states is associated with a respective set of activities that are enabled for that dormancy state; and
switch the set of frequency resources to the first dormancy state.

30. An apparatus for wireless communication, comprising:
means for receiving an indication of a first dormancy state, of a plurality of dormancy states, for a set of frequency resources within a bandwidth part of a component carrier, wherein each dormancy state of the plurality of dormancy states is associated with a respective set of activities that are enabled for that dormancy state; and
means for switching the set of frequency resources to the first dormancy state.
